(19) United States
(12) Patent Application Publication
(10) Pub. No.: US 2023/0110277 A1
(43) Pub. Date: Apr. 13, 2023

(54) CRAWFISH ICE CHEST WATER CIRCULATION DEVICE

(71) Applicant: Troy L. Caron, Jefferson, LA (US)

(72) Inventor: Troy L. Caron, Jefferson, LA (US)

(21) Appl. No.: 17/497,443

(22) Filed: Oct. 8, 2021

(51) Int. Cl. A22C 29/02; A01K 63/04

(52) U.S. Cl. CPC A22C 29/021; A01K 63/042

(57) ABSTRACT

A device for flushing seafood includes a cylindrical conduit having a connector end connected to a water flow valve and an elbow end having an elbow fitting. A water discharging drop pipe connected to the elbow fitting defines water discharging orifices. The drop pipe is fixed to an inner support leg, a bend is connected to the cylindrical pipe, and the outer clamp is engaged to an outer surface of an ice chest via threaded bolt in a removable mounted position. The inner support leg engages an inner surface of the ice chest when the drop pipe is disposed inside the ice chest such that when the water flow valve is opened a flow of water through the drop pipe discharges the water out through the water discharging orifices toward the inner surface of the ice chest in a spaced relationship to the drop pipe.

### BACKGROUND OF THE INVENTION

### Field of the Invention

The present invention generally relates to a water circulation device and more particularly relates to a water circulation device for flushing seafood in an ice chest.

### Description of the Related Art

With the growing population of domesticated pets, cooks and crawfish boilers alike have the responsibility of flushing crawfish with water to purge them prior to a crawfish boil for reasons of sanitation and better texture and flavor. The manner in which a person flushes the crawfish needs to be sanitary and easy to accomplish in order to produce a better product in a more time efficient manner and for reasons of people's health and well-being. Currently, a common method for flushing crawfish is to insert the end of a hose into an ice chest or other container and let the water overflow over the edges; however, the garden hose often moves around within the ice chest, whips itself and dislodge from the ice chest thereby not accomplishing the desired purging of the crawfish.

Over the years, various devices have been made to assist people with the flushing of crawfish and other seafood. However, such commonly known devices are of complex construction, largely inefficient in operation, and often result in contamination of a person's hands. Handling seafood in such a way is not hygienic or sanitary and can lead to the spreading of unhealthy germs and health concerns. There is a need for a hand-held, sanitary, and portable device for cooks to easily and efficiently flush crawfish before a crawfish boil.

Conventional devices have been developed over the years for flushing crawfish, but those devices are often complex, difficult to properly position, and directly jet water at the crawfish which can prove harmful to the crawfish when in use.

While such units may be suitable for the particular purpose employed, they would not be as suitable for the purposes of the present invention as disclosed hereafter.

Accordingly, there is a need for a compact portable lightweight water circulation device for attending to the flushing of crawfish and other seafood in a more convenient, effective and sanitary manner.

As disclosed in this application, the inventor has discovered novel and unique devices and methods for efficient and sanitary flushing of seafood in an ice chest or in a cooking pot, which exhibit superlative properties without being dependent on heavy, immobile, expensive or complex components.

Embodiments of the present invention provide for devices and methods and disclosed herein and as defined in the annexed claims which provide for improved water circulation features in order to efficiently flush seafood in an ice chest and in a cooking pot, in a sanitary manner, for people's health and well-being.

### SUMMARY OF THE INVENTION

It is one prospect of the present invention to provide one or more novel devices of simple but effective construction which can be applied to many environments to efficiently and effectively circulate water in an ice chest and flush seafood.

The following presents a simplified summary of the present disclosure in a simplified form as a prelude to the more detailed description that is presented herein.

Therefore, in accordance with embodiments of the invention, there is provided a portable ice chest water circulation device for flushing seafood. In one embodiment, the device includes a cylindrical conduit having a connector end opposite an elbow end. The connector end comprises a water flow valve having a garden hose connection adapter configured to provide a fluid connection to a standard garden hose. Additionally, the elbow end includes an elbow fitting connected to an elongated cylindrical water discharging drop pipe in fluid communication with the cylindrical conduit. Further, the elongated cylindrical water discharging drop pipe includes a top portion and a bottom portion. The bottom portion defines a linearly aligned row of round water discharging orifices.

In one embodiment, the portable ice chest water circulation device includes an outer clamp leg connected by a bend to an inner support leg. The outer clamp leg and the inner support leg each extends in parallel from the bend. Further, the bend is fixed to the elbow end and is adapted to securely engage a top of a wall of an ice chest in a removably mounted position.

In one embodiment, the inner support leg comprises an elongated flat plate fixed to the elongated cylindrical water discharging drop pipe. Additionally, the outer clamp leg includes an elongated flat plate having a lower end which defines an internally threaded hole and comprises a threaded bolt disposed perpendicularly through the internally threaded hole. The threaded bolt is adapted to engage an outer surface of the wall of the ice chest when the bend of the device securely engages with the top of the wall of the ice chest in the removably mounted position.

In a preferred embodiment, the inner support leg engages an inner surface of the wall of the ice chest when the elongated cylindrical water discharging drop pipe is disposed inside the ice chest in the removably mounted position such that when the water flow valve is opened a flow of water through the elongated cylindrical water discharging drop pipe discharges the water out of the linearly aligned row of the round water discharging orifices toward the inner surface of the ice chest in a spaced relationship to the elongated cylindrical water discharging drop pipe for circulating water. This avoids the direct impact of the discharging water on the seafood when disposed therein.

Preferably, when the bend is in the removably mounted position, each round water discharging orifice of the linearly aligned round water discharging orifices is oriented angularly at an approximately forty-five degrees (45°) angle relative to the inner surface of the ice chest.

In yet another embodiment, when the bend is in the removably mounted position, each round water discharging orifice of the linearly aligned round water discharging orifices is oriented angularly at an approximately ninety degree (90°) angle relative to the inner surface of the ice chest.

In a preferred embodiment, the bend comprises an arcuate shape. An upper end portion of the outer clamp leg is characterized as higher than an upper end portion of the inner support leg relative to the top of the wall of the ice chest when the bend is in the removably mounted position.

Preferably, the bend is sized and configured to closely align with and fit against the top of the wall of the ice chest.

In one embodiment, when the ice chest is filled with water, the elongated cylindrical water discharging drop pipe is characterized as having a length sufficient to extend the linearly aligned row of the round water discharging orifices beneath a top surface of the water when the bend is in the removably mounted position.

In one embodiment, the outer clamp leg comprises a length that is shorter than a length of the inner support leg.

In a preferred embodiment, the inner support leg is characterized as having a thickness sufficient to provide an air space between the elongated cylindrical water discharging drop pipe and the inner surface of the ice chest.

In another embodiment, the portable ice chest water circulation device includes at least a first zip-tie. The bend is fixed to the elbow end with the at least a first zip-tie.

In another embodiment, the portable ice chest water circulation device includes at least a second zip-tie. The inner support leg is fixed to the elongated cylindrical water discharging drop pipe with the at least a second zip-tie.

In one embodiment, the cylindrical conduit includes a larger diameter than a diameter of the elongated cylindrical water discharging drop pipe, which helps produce a jet effect.

In one embodiment, the elongated cylindrical water discharging drop pipe includes an end cap connected to a bottom tip of the bottom portion of the elongated cylindrical water discharging drop pipe.

In accordance with embodiments of the invention, there is provided a portable water circulation device for flushing seafood in a cooking pot. The device comprises a cylindrical conduit having a connector end opposite an elbow end. The connector end comprises a water flow valve having a garden hose connection adapter configured to provide a fluid connection to a standard garden hose. The elbow end includes an elbow fitting connected to an elongated cylindrical water discharging drop pipe in fluid communication with the cylindrical conduit. The elongated cylindrical water discharging drop pipe includes a top portion and a bottom portion. The bottom portion defines a linearly aligned row of round water discharging orifices.

In one embodiment, the device includes an outer clamp leg connected by a bend to an inner support leg. The outer clamp leg and inner support leg each extends in parallel from the bend. The bend is fixed to the elbow end and is adapted to securely engage a top of a wall of the cooking pot in a removably mounted position.

In one embodiment, the inner support leg comprises an elongated flat plate fixed to the elongated cylindrical water discharging drop pipe. The outer clamp leg includes an elongated flat plate having a lower end that defines an internally threaded hole and comprises a threaded bolt disposed perpendicularly through the internally threaded hole. The threaded bolt is adapted to engage an outer surface of the wall of the cooking pot when the bend of the device securely engages the top of the wall of the cooking pot in the removably mounted position.

In one embodiment, the inner support leg engages an inner surface of the wall of the cooking pot and the elongated cylindrical water discharging drop pipe is disposed inside the cooking pot in the removably mounted position such that when the water flow valve is opened a flow of water through the elongated cylindrical water discharging drop pipe discharges the water out of the linearly aligned row of round water discharging orifices toward the inner surface of the cooking pot, in a spaced relationship to the water discharging drop pipe, for circulating water. This avoids the direct impact of the discharging water on the seafood when disposed therein.

In one embodiment, when the bend is in the removably mounted position, each round water discharging orifice of the linearly aligned round water discharging orifices is oriented angularly at an approximately forty-five degree (45°) angle relative to the inner surface of the cooking pot.

In another embodiment, when the bend is in the removably mounted position, each round water discharging orifice of the linearly aligned round water discharging orifices is oriented angularly at an approximately ninety degrees (90°) angle relative to the inner surface of the cooking pot.

In one embodiment, the bend comprises an arcuate shape. An upper end portion of the outer clamp leg is characterized as higher than an upper end portion of the inner support leg relative to the top of the wall of the cooking pot when the bend is in the removably mounted position.

In one embodiment, the bend is sized and configured to closely align with and fit against the top of the wall of the cooking pot.

In one embodiment, when the cooking pot is filled with water, the elongated cylindrical water discharging drop pipe is characterized as having a length sufficient to extend the linearly aligned row of round water discharging orifices beneath a top surface of the water when the bend is in the removably mounted position.

In one embodiment, the outer clamp leg comprises a length that is shorter than a length of the inner support leg.

In a preferred embodiment, the inner support leg is characterized as having a thickness sufficient to provide an air space between the elongated cylindrical water discharging drop pipe and the inner surface of the cooking pot.

In one embodiment, the portable water circulation device for flushing seafood includes at least a first zip-tie. The bend is fixed to the elbow end with the at least a first zip-tie.

In one embodiment, the portable water circulation device for flushing seafood includes at least a second zip-tie. The inner support leg is fixed to the elongated cylindrical water discharging drop pipe with the at least a second zip-tie.

In one embodiment, the cylindrical conduit comprises a larger diameter than a diameter of the elongated cylindrical water discharging drop pipe.

In one embodiment, the elongated cylindrical water discharging drop pipe includes an end cap connected to a bottom tip of the bottom portion of the elongated cylindrical water discharging drop pipe.

Therefore, in accordance with embodiments of the invention, there is provided a portable ice chest water circulation device for flushing seafood. The device includes a cylindrical conduit having a connector end opposite an elbow end. The cylindrical conduit has an elongated flat plate clamp leg disposed perpendicular to the cylindrical conduit. The elongated flat plate clamp leg has a lower end which defines an internally threaded hole and which comprises a threaded bolt disposed perpendicularly through the internally threaded hole. The threaded bolt is adapted to engage an outer surface of a wall of an ice chest. In addition, the connector end includes a water flow valve having a garden hose connection adapter configured to provide a fluid connection to a standard garden hose.

In an embodiment, the elbow end comprises an elongated cylindrical water discharging drop pipe in fluid communication with the cylindrical conduit. The elongated cylindrical water discharging drop pipe has a top portion and a bottom portion. The top portion has a flat sidewall adapted to securely engage an inner surface of the wall of the ice chest in a removably mounted position. The bottom portion defines a linearly aligned row of round water discharging orifices.

In the preferred embodiment, the elongated flat plate clamp leg engages the inner surface of the wall of the ice chest when the elongated cylindrical water discharging drop pipe is disposed inside the ice chest in the removably mounted position such that when the water flow valve is opened a flow of water through the elongated cylindrical water discharging drop pipe discharges the water out through the linearly aligned row of round water discharging orifices toward the inner surface of the wall of the ice chest in a spaced relationship to the elongated cylindrical water discharging drop pipe for circulating water therein while avoiding direct impact of the discharging water on the seafood when disposed therein.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which like numerals throughout the figures identify substantially similar components, in which:

FIG. 1 is a front view of a portable ice chest water circulation device for flushing seafood, in accordance with embodiments of the invention;

FIG. 2 is a perspective view of the portable ice chest water circulation device for flushing seafood, in accordance with embodiments of the invention;

FIG. 3A illustrates a water discharging drop pipe having a plurality of round water discharging orifices, in accordance with embodiments of the invention;

FIG. 3B illustrates the water discharging drop pipe having a plurality of round water discharging orifices arranged in a perfect straight line, in accordance with embodiments of the invention

FIG. 4 is a side perspective view of an ice chest including the portable ice chest water circulation device for flushing seafood, in accordance with embodiments of the invention;

FIG. 5 is a top perspective view of the ice chest including the portable ice chest water circulation device for flushing seafood, in accordance with embodiments of the invention;

FIG. 6 is a side perspective view of a cooking pot including a portable water circulation device for flushing seafood inside the cooking pot, in accordance with embodiments of the invention;

FIG. 7 is a top perspective view of the cooking pot including the portable water circulation device for flushing seafood inside the cooking pot, in accordance with embodiments of the invention;

FIG. 8A is a front view of an embodiment of a portable ice chest water circulation device for flushing seafood, in accordance with embodiments of the invention;

FIG. 8B is a front view of another embodiment of a portable ice chest water circulation device for flushing seafood, in accordance with embodiments of the invention;

FIG. 9 is a side perspective view of the embodiment of a portable ice chest water circulation device for flushing seafood shown in FIG. 8A, in accordance with embodiments of the invention; and

FIG. 10 is a top perspective view of an embodiment of an ice chest including the portable ice chest water circulation device for flushing seafood of FIG. 8A, in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

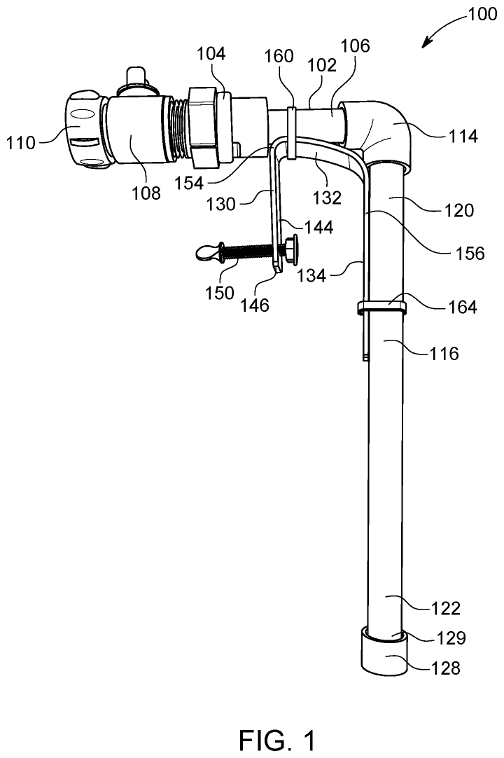

Referring initially to FIGS. 1-5, the basic constructional details and principles of operation of one embodiment of an ice chest water circulation device 100 (hereinafter referred to as a device) according to a preferred embodiment of the present invention will be discussed.

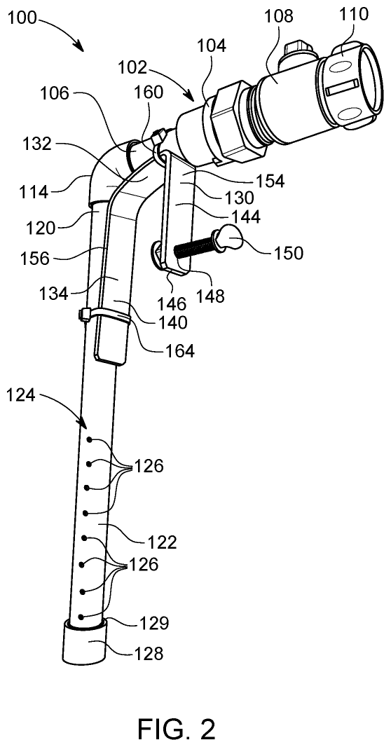

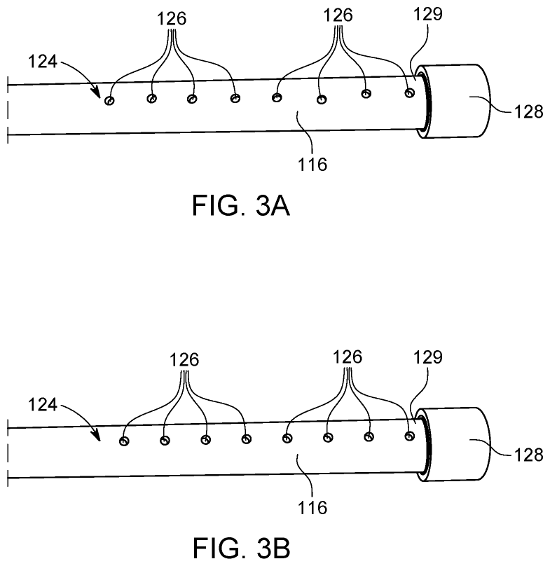

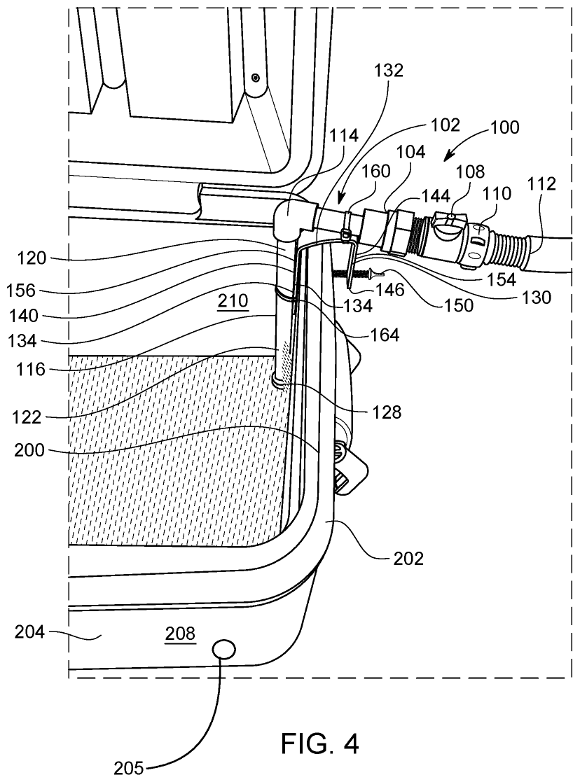

As illustrated in FIGS. 1, 2, 4 and 5, in a preferred embodiment, a portable ice chest water circulation device 100 for flushing seafood is provided. The device 100 includes a cylindrical conduit 102 having a connector end 104 opposite an elbow end 106. The connector end 104 includes a water flow valve 108 having a garden hose connection adapter 110 configured to provide a fluid connection to a standard garden hose 112, as exemplified in FIG. 4. Additionally, the elbow end 106 includes an elbow fitting 114 connected to an elongated cylindrical water discharging drop pipe 116 in fluid communication with the cylindrical conduit 102. Further, the elongated cylindrical water discharging drop pipe 116 includes a top portion 120 and a bottom portion 122 defining a linearly aligned row 124 of round water discharging orifices 126, as exemplified in FIG. 2. In one embodiment, as exemplified in FIG. 3B, the water discharging orifices 126 are aligned in a perfect straight line. However, the water discharging orifices 126 may be offset from the perfect straight line, as exemplified in FIG. 3A. In an embodiment, the cylindrical conduit 102 includes a larger diameter than a diameter of the elongated cylindrical water discharging drop pipe 116. Further, the elongated cylindrical water discharging drop pipe 116 includes an end cap 128 connected to a bottom tip 129 of the bottom portion 122 of the elongated cylindrical water discharging drop pipe 116.

Further, the device 100 includes an outer clamp leg 130 connected by a bend 132 to an inner support leg 134. The outer clamp leg 130 and the inner support leg 134 each extends in parallel from the bend 132. In an embodiment, the inner support leg 134 comprises a length that is shorter than a length of the outer clamp leg 130. In addition, the bend 132 is fixed or attached to the elbow end 106 and adapted to securely engage a top 200 of a wall 202 of an ice chest 204 in a removably mounted position, as exemplified in FIG. 4.

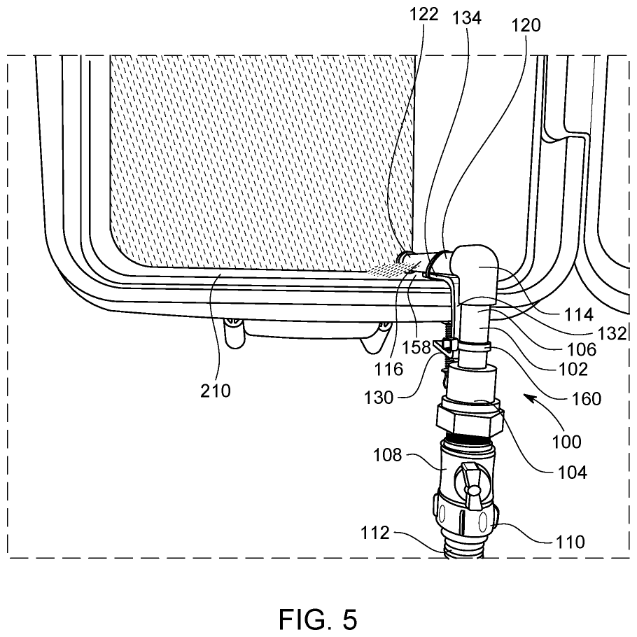

Further, the inner support leg 134 includes an elongated flat plate 140, as exemplified in FIG. 2 and FIG. 4, fixed to the elongated cylindrical water discharging drop pipe 116. Additionally, the outer clamp leg 130 includes an elongated flat plate 144 having a lower end 146 which defines an internally threaded hole 148 (best shown in FIG. 2) and comprises a threaded bolt 150 disposed perpendicularly through the internally threaded hole 148. As exemplified in FIG. 4, the threaded bolt 150 is adapted to engage an outer surface 208 of the wall 202 of the ice chest 204 when the bend 132 of the device 100 securely engages with the top 200 of the wall 202 of the ice chest 204 in the removably mounted position, as exemplified in FIG. 4 and FIG. 5.

Furthermore, as exemplified in FIG. 4, the inner support leg 134 engages an inner surface 210 of the wall 202 of the ice chest 204 when the elongated cylindrical water discharging drop pipe 116 is disposed inside the ice chest 204 in the removably mounted position such that when the water flow valve 108 is opened a flow of water through the elongated cylindrical water discharging drop pipe 116 discharges the water out of the linearly aligned row 124 of the round water discharging orifices 126 toward the inner surface 210 of the wall 202 of the ice chest 204 in a spaced relationship to the elongated cylindrical water discharging drop pipe 116 for circulating water. This avoids the direct impact of the discharging water on the seafood arranged inside the ice chest 204. A drain hole 205 is disposed in the wall 202 near the bottom of the ice chest 204 to allow water to drain out of the ice chest 204 when a user is flushing the seafood with water.

In an embodiment, each round water discharging orifice 126 of the linearly aligned round water discharging orifices 128 is oriented angularly at an approximately forty-five degree (45°) angle relative to the inner surface 210 of the wall 202 the ice chest 204 when the bend 132 is removably mounted to the ice chest 204. In some embodiments, each round water discharging orifice 128 of the linearly aligned round water discharging orifices 126 is oriented angularly at an approximately ninety-degree (90°) angle relative to the inner surface 210 of the ice chest 204 when the bend 132 is in the removable mounted position.

As exemplified in FIG. 1, FIG. 2, and FIG. 4, the bend 132 comprises an arcuate shape and is sized such that the bend 132 closely aligns and fits against the top 200 of the wall 202 of the ice chest 204. As exemplified in FIG. 4, the bend 132 includes the arcuate shape such that an upper end portion 154 of the outer clamp leg 130 is characterized as or located higher than an upper end portion 156 of the inner support leg 134 relative to the top 200 of the wall 202 of the ice chest 204 when the bend 132 is in the removably mounted position. Further, when the ice chest 204 is filled with water, the elongated cylindrical water discharging drop pipe 116 is characterized as having a length sufficient to extend the linearly aligned row 124 of the round water discharging orifices 128 beneath a top surface of the water when the bend 132 is in the removably mounted position.

As exemplified in FIG. 4 and FIG. 5, the inner support leg 134 is characterized as having a thickness sufficient to provide an air space between the elongated cylindrical water discharging drop pipe 116 and the inner surface 210 of the ice chest 204. Further, the device 100 includes at least a first zip-tie 160 to facilitate a secure attachment of the bend 132 to the elbow end 106. Additionally, the device 100 includes at least a second zip-tie 164 to facilitate a secure attachment of the inner support leg 134 with the elongated cylindrical water discharging drop pipe 116.

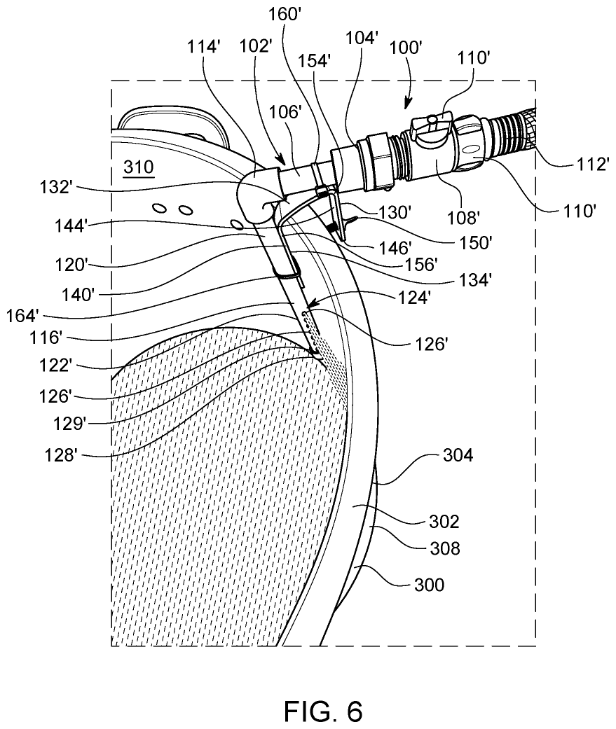

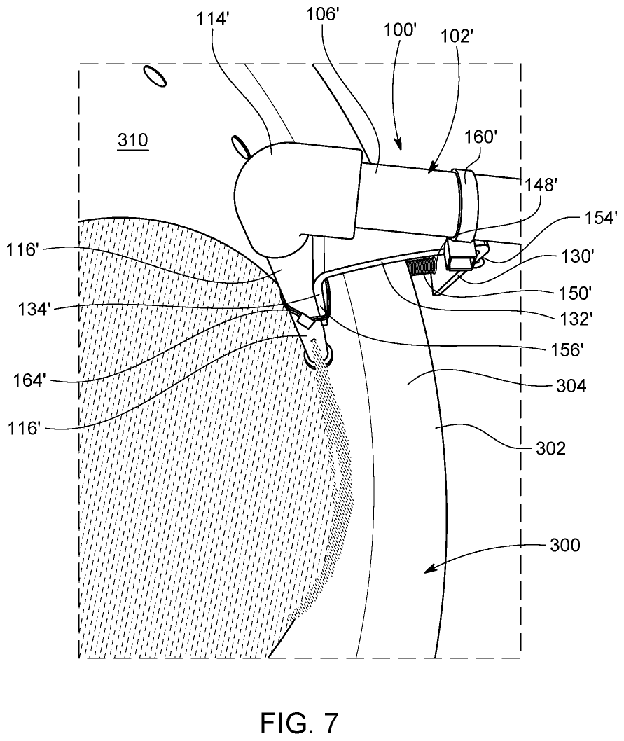

Referring to FIG. 6 and FIG. 7, in one embodiment, a portable water circulation device 100′ (hereinafter referred to as a device 100′) for flushing seafood in a cooking pot 300 is provided. The device 100′ comprising a cylindrical conduit 102′ having a connector end 104′ opposite an elbow end 106′. The connector end 104′ includes a water flow valve 108′ having a garden hose connection adapter 110′ configured to provide a fluid connection to a standard garden hose 112′, as exemplified in FIG. 6. As shown, the elbow end 106′ includes an elbow fitting 114′ connected to an elongated cylindrical water discharging drop pipe 116′ in fluid communication with the cylindrical conduit 102′.

The elongated cylindrical water discharging drop pipe 116′ includes a top portion 120′ opposite a bottom portion 122′, and the bottom portion 122′ defines a linearly aligned row 124′ of the round water discharging orifices 128′. In one embodiment, as exemplified in FIG. 3B, the water discharging orifices 126 are aligned in a perfect straight line, and the water that is discharging from the water discharging orifices 126 circulates water within the cooking pot 300. However, in a preferred embodiment, the water discharging orifices 126 are offset from the perfect straight line, as exemplified in FIG. 3A, to better agitate the water contained within the cooking pot 300 in multiple directions.

In an embodiment, the water discharging orifices 126′ are aligned in a perfect straight line. However, the water discharging orifices 126′ may be offset from the perfect straight line. In an embodiment, the cylindrical conduit 102′ includes a larger diameter than a diameter of the elongated cylindrical water discharging drop pipe 116′. Further, the elongated cylindrical water discharging drop pipe 116′ includes an end cap 128′ connected to a bottom tip 129′ of the bottom portion 122′ of the elongated cylindrical water discharging drop pipe 116′. Further, the device 100′ includes an outer clamp leg 130′ connected by a bend 132′ to an inner support leg 134′. The outer clamp leg 130′ and inner support leg 134′ each extends in parallel from the bend 132′. In an embodiment, the outer clamp leg 130″ comprises a length that is shorter than a length of the inner support leg 134′. In addition, the bend 132′ is fixed or attached to the elbow end 106′ and is adapted to securely engage a top 302 of a wall 304 of the cooking pot 300 in a removably mounted position, as exemplified in FIGS. 6 and 7.

Further, the inner support leg 134′ includes an elongated flat plate 140′ fixed to the elongated cylindrical water discharging drop pipe 116′. In addition, the outer clamp leg 130′ includes an elongated flat plate 144′ having a lower end 146′ which defines an internally threaded hole 148′, as exemplified in FIG. 7, and comprises a threaded bolt 150′ disposed perpendicularly through the internally threaded hole 148′. The threaded bolt 150′ is adapted to engage an outer surface 308 of the wall 304 of the cooking pot 300 when the bend 132′ of the device 100′ securely engages the top 302 of the wall 304 of the cooking pot 300 in the removably mounted position, as exemplified in FIGS. 6 and 7.

Furthermore, as exemplified in FIGS. 6 and 7, the inner support leg 134′ engages an inner surface 310 of the wall 304 of the cooking pot 300, and the elongated cylindrical water discharging drop pipe 116′ is disposed inside the cooking pot 300 in the removably mounted position of the bend 132′ such that when the water flow valve 108′ is opened a flow of water through the elongated cylindrical water discharging drop pipe 116′ discharges the water out of the linearly aligned row 124′ of the round water discharging orifices 126′ toward the inner surface 310 of the wall 304 of the cooking pot 300 in a spaced relationship to the water discharging drop pipe 116′ for circulating water. This avoids the direct impact of the discharging water on the seafood arranged inside the cooking pot 300. As shown, the inner support leg 134′ is characterized as having a thickness sufficient to provide an air space between the elongated cylindrical water discharging drop pipe 116′ and the inner surface 310 of the wall 304 of the cooking pot 300.

In an embodiment, each round water discharging orifice 126′ of the linearly aligned round water discharging orifices 126′ is oriented angularly at an approximately forty-five-degree (45°) angle relative to the inner surface 310 of the wall 304 of the cooking pot 300 when the bend 132′ is removably mounted to the cooking pot 300.

In some embodiments, each round water discharging orifice 126′ of the linearly aligned round water discharging orifices 126′ is oriented angularly at an approximately ninety-degree (90°) angle relative to the inner surface 310 of the wall 304 of the cooking pot 300 when the bend 132′ is in removable mounted position.

In an embodiment, the bend 132′ comprises an arcuate shape and is sized such that the bend 132′ closely aligns and fits against the top 302 of the wall 304 of the cooking pot 300. As exemplified in FIG. 6, the bend 132′ includes the arcuate shape such that an upper end portion 154′ of the outer clamp leg 130′ is characterized as or located higher than an upper end portion 156′ of the inner support leg 134′ relative to the top 302 of the wall 304 of the cooking pot 300 when the bend 132′ is in the removably mounted position as exemplified in FIG. 6.

Additionally, the elongated cylindrical water discharging drop pipe 116′ is characterized as having a length sufficient to extend the linearly aligned row 124′ of the round water discharging orifices 128′ beneath a top surface of the water when the bend 132′ is in the removably mounted position and the cooking pot 300 is filled with water.

In addition, the device 100′ includes at least a first zip-tie 160′ to facilitate a secure attachment of the blend 132′ to the elbow end 106′. Further, the device 100′ includes a second zip-tie 164′ to facilitate a secure attachment of the inner support leg 134′ with the elongated cylindrical water discharging drop pipe 116′.

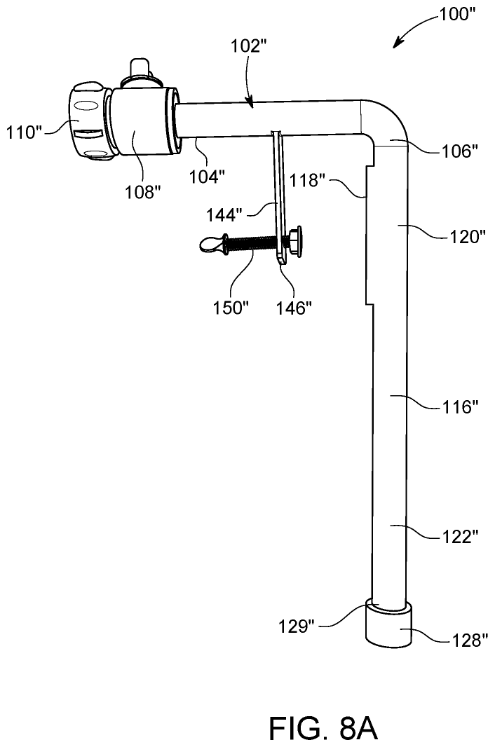

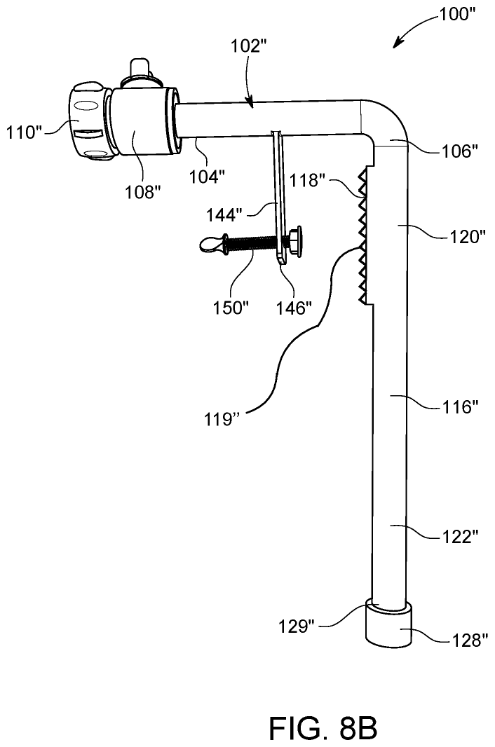

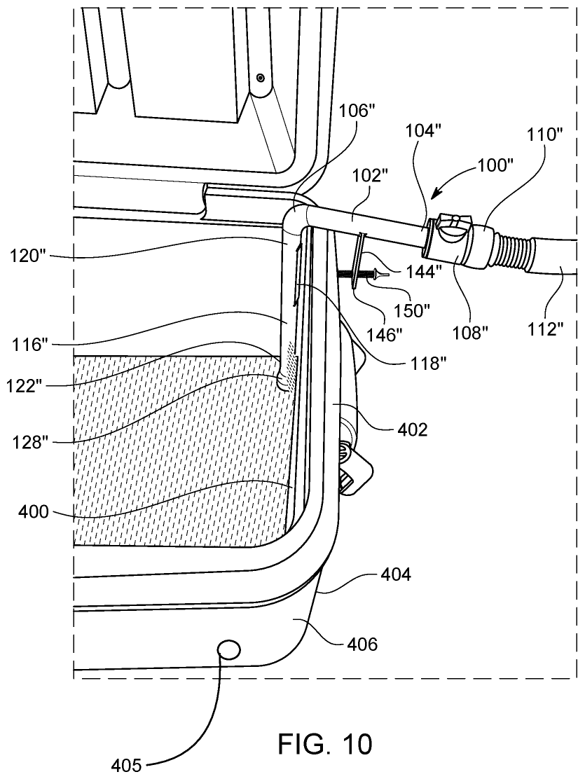

As illustrated in FIG. 8A through FIG. 10, embodiments of a portable ice chest water circulation device 100″ for flushing seafood are provided. The device 100″ includes a cylindrical conduit 102″ having a connector end 104″ opposite an elbow end 106″. The connector end 104″ includes a water flow valve 108″ preferably having a garden hose connection adapter 110″ configured to provide a fluid connection to a standard garden hose 112″, as exemplified in FIG. 10. Further, the elbow end 106″ includes an elongated cylindrical water discharging drop pipe 116″ in fluid communication with the cylindrical conduit 102″. The portable ice chest water circulation device 100″ for flushing seafood is removably mounted to an ice chest 404, as illustrated in FIG. 10.

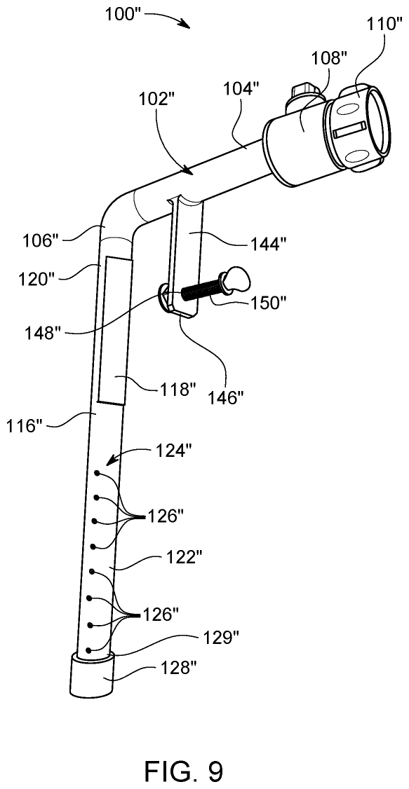

The elongated cylindrical water discharging drop pipe 116″ includes a top portion 120″ and a bottom portion 122″. In one embodiment, the top portion 120″ has a flat sidewall 118″, as exemplified in FIG. 8A, FIG. 9 and FIG. 10, adapted to securely engage an inner surface 400 of a wall 402 of the ice chest 404 in a removably mounted position. In a preferred embodiment, the top portion 120″ has a rugged sidewall having teeth 119″, as exemplified in FIG. 8B, and the teeth 119″ are adapted to grip the inner surface 400 of the wall 402 of the ice chest 404 in the removably mounted position.

Further, the bottom portion 122″ of elongated cylindrical water discharging drop pipe 116″ defines a linearly aligned row 124″ of round water discharging orifices 126″, as exemplified in FIG. 9. In one embodiment, as exemplified in FIG. 3B, the water discharging orifices 126 are aligned in a perfect straight line, and the water discharging from the water discharging orifices 126 circulates water within the ice chest 404. However, in a preferred embodiment, the water discharging orifices 126 are offset from the perfect straight line, as exemplified in FIG. 3A, to better agitate the water contained within the ice chest 404 in multiple directions. In an embodiment, each round water discharging orifice 126″ of the linearly aligned round water discharging orifices 126″ is oriented angularly at an approximately forty-five degree (45°) angle relative to the inner surface 400 of the wall 402 of the ice chest 404 when the elongated flat clamp leg 144″ is removably mounted to the ice chest 404. In some embodiments, each round water discharging orifice 126″ of the linearly aligned round water discharging orifices 126″ is oriented angularly at an approximately ninety degree (90°) angle relative to the wall 402 of the ice chest 404 when the elongated flat clamp leg 144″ is in removable mounted position. Further, the elongated cylindrical water discharging drop pipe 116″ includes an end cap 128″ arranged at a bottom tip 129″ of the bottom portion 122″.

Moreover, the cylindrical conduit 102″ includes an elongated flat plate clamp leg 144″ disposed perpendicular to the cylindrical conduit 102″. The elongated flat plate clamp leg 144″ includes a lower end 146″ which defines an internally threaded hole 148″, shown in FIG. 9, and which comprises a threaded bolt 150″ disposed perpendicularly through the internally threaded hole 148″. As shown in FIG. 10, the threaded bolt 150″ is adapted to engage an outer surface 406 of the wall 402 of the ice chest 404.

In the preferred embodiment, as exemplified in FIG. 10, the flat sidewall 118″ engages the inner surface 400 of the wall 402 of the ice chest 404 when the elongated cylindrical water discharging drop pipe 116″ is disposed inside the ice chest 404 in the removably mounted position such that when the water flow valve 108″ is opened a flow of water through the elongated cylindrical water discharging drop pipe 116″ discharges the water out and the linearly aligned row 124″ of round water discharging orifices 126″ toward the inner surface 400 of the wall 402 of the ice chest 404 in a spaced relationship to the elongated cylindrical water discharging drop pipe 116″ for circulating water while avoiding the direct impact of the discharging water on the seafood when disposed therein. A drain hole 405 is disposed in the wall 402 near the bottom of the ice chest 404 to allow water to drain out of the ice chest 404 when a user is flushing the crawfish with water.

As exemplified in FIG. 10, the flat plate clamp leg 144″ is characterized as having a thickness sufficient to provide an air space between the elongated cylindrical water discharging drop pipe 116″ and the inner surface 400 of the ice chest 404.

The claimed invention is:

1. A portable ice chest water circulation device for flushing seafood, comprising:
a cylindrical conduit having a connector end opposite an elbow end, the connector end comprising a water flow valve having a garden hose connection adapter configured to provide a fluid connection to a standard garden hose, the elbow end having an elbow fitting connected to an elongated cylindrical water discharging drop pipe in fluid communication with the cylindrical conduit,
the elongated cylindrical water discharging drop pipe having a top portion and a bottom portion, said bottom portion defining a linearly aligned row of round water discharging orifices;
an outer clamp leg connected by a bend to an inner support leg, the outer clamp leg and the inner support leg each extending in parallel from the bend,
said bend fixed to the elbow end and adapted to securely engage a top of a wall of an ice chest in a removably mounted position,
said inner support leg comprising an elongated flat plate fixed to the elongated cylindrical water discharging drop pipe, the outer clamp leg comprising an elongated flat plate having a lower end which defines an internally threaded hole and comprises a threaded bolt disposed perpendicularly through said internally threaded hole, the threaded bolt adapted to engage an outer surface of the wall of the ice chest when the bend of the device securely engages the top of the wall of the ice chest in the removably mounted position,
wherein the inner support leg engages an inner surface of the wall of the ice chest when the elongated cylindrical water discharging drop pipe is disposed inside the ice chest in the removably mounted position such that when the water flow valve is opened a flow of water through the elongated cylindrical water discharging drop pipe discharges said water out said linearly aligned row of round water discharging orifices toward the inner surface of the ice chest in a spaced relationship to the elongated cylindrical water discharging drop pipe for circulating water therein while avoiding direct impact of said discharging water on the seafood when disposed therein.

2. The portable ice chest water circulation device of claim 1, when said bend is in the removably mounted position, each round water discharging orifice of the linearly aligned round water discharging orifices is oriented angularly at an approximately forty-five degree (45°) angle relative to the inner surface of the ice chest.

3. The portable ice chest water circulation device of claim 1, when said bend is in the removably mounted position, each round water discharging orifice of the linearly aligned round water discharging orifices is oriented angularly at an approximately ninety degree (90°) angle relative to the inner surface of the ice chest.

4. The portable ice chest water circulation device of claim 1, wherein the bend comprises an arcuate shape, wherein an upper end portion of the outer clamp leg is characterized as higher than an upper end portion of the inner support leg relative to the top of the wall of the ice chest when said bend is in the removably mounted position.

5. The portable ice chest water circulation device of claim 1, wherein the bend is sized and configured to closely align with and fit against the top of the wall of the ice chest.

6. The portable ice chest water circulation device of claim 1, wherein when the ice chest is filled with water, the elongated cylindrical water discharging drop pipe is characterized as having a length sufficient to extend the linearly aligned row of round water discharging orifices beneath a top surface of the water when said bend is in the removably mounted position.

7. The portable ice chest water circulation device of claim 3, wherein the outer clamp leg comprises a length that is shorter than a length of the inner support leg.

8. The portable ice chest water circulation device of claim 3, wherein the inner support leg is characterized as having a thickness sufficient to provide an air space between said elongated cylindrical water discharging drop pipe and said inner surface of the ice chest.

9. The portable ice chest water circulation device of claim 1, further comprising at least a first zip-tie, wherein the bend is fixed to the elbow end with said at least a first zip-tie.

10. The portable ice chest water circulation device of claim 9, further comprising at least a second zip-tie, wherein the inner support leg is fixed to the elongated cylindrical water discharging drop pipe with said at least a second zip-tie.

11. The portable ice chest water circulation device of claim 1, wherein the cylindrical conduit comprises a larger diameter than a diameter of the elongated cylindrical water discharging drop pipe.

12. The portable ice chest water circulation device of claim 1, the elongated cylindrical water discharging drop pipe further comprising an end cap connected to a bottom tip of the bottom portion of the elongated cylindrical water discharging drop pipe.

13. A portable water circulation device for flushing seafood in a cooking pot, comprising:
a cylindrical conduit having a connector end opposite an elbow end, the connector end comprising a water flow valve having a garden hose connection adapter configured to provide a fluid connection to a standard garden hose, the elbow end having an elbow fitting connected to an elongated cylindrical water discharging drop pipe in fluid communication with the cylindrical conduit,
the elongated cylindrical water discharging drop pipe having a top portion and a bottom portion, said bottom portion defining a linearly aligned row of round water discharging orifices;
an outer clamp leg connected by a bend to an inner support leg, the outer clamp leg and inner support leg each extending in parallel from the bend,
said bend fixed to the elbow end and adapted to securely engage a top of a wall of the cooking pot in a removably mounted position,
said inner support leg comprising an elongated flat plate fixed to the elongated cylindrical water discharging drop pipe, the outer clamp leg comprising an elongated flat plate having a lower end which defines an internally threaded hole and comprises a threaded bolt disposed perpendicularly through said internally threaded hole, the threaded bolt adapted to engage an outer surface of the wall of the cooking pot when the bend of the device securely engages the top of the wall of the cooking pot in the removably mounted position,
wherein the inner support leg engages an inner surface of the wall of the cooking pot and the elongated cylindrical water discharging drop pipe is disposed inside the cooking pot in the removably mounted position such that when the water flow valve is opened a flow of water through the elongated cylindrical water discharging drop pipe discharges said water out said linearly aligned row of round water discharging orifices toward the inner surface of the cooking pot in a spaced relationship to the water discharging drop pipe for circulating water therein while avoiding direct impact of said discharging water on the seafood when disposed therein.

14. The portable water circulation device for flushing seafood in a cooking pot of claim 13, when said bend is in the removably mounted position, each round water discharging orifice of the linearly aligned round water discharging orifices is oriented angularly at an approximately forty-five degree (45°) angle relative to the inner surface of the cooking pot.

15. The portable water circulation device for flushing seafood in a cooking pot of claim 13, when said bend is in the removably mounted position, each round water discharging orifice of the linearly aligned round water discharging orifices is oriented angularly at an approximately ninety degree (90°) angle relative to the inner surface of the cooking pot.

16. The portable water circulation device for flushing seafood in a cooking pot of claim 13, wherein the bend comprises an arcuate shape, wherein an upper end portion of the outer clamp leg is characterized as higher than an upper end portion of the inner support leg relative to the top of the wall of the cooking pot when said bend is in the removably mounted position.

17. The portable water circulation device for flushing seafood in a cooking pot of claim 13, wherein the bend is sized and configured to closely align with and fit against the top of the wall of the cooking pot.

18. The portable water circulation device for flushing seafood in a cooking pot of claim 13, wherein when the cooking pot is filled with water, the elongated cylindrical water discharging drop pipe is characterized as having a length sufficient to extend the linearly aligned row of round water discharging orifices beneath a top surface of the water when said bend is in the removably mounted position.

19. The portable water circulation device for flushing seafood in a cooking pot of claim 13, wherein the outer clamp leg comprises a length that is shorter than a length of the inner support leg.

20. The portable water circulation device for flushing seafood in a cooking pot of claim 13, wherein the inner support leg is characterized as having a thickness sufficient to provide an air space between said elongated cylindrical water discharging drop pipe and said inner surface of the cooking pot.

21. The portable water circulation device for flushing seafood in a cooking pot of claim 13, further comprising at least a first zip-tie, wherein the bend is fixed to the elbow end with said at least a first zip-tie.

22. The portable water circulation device for flushing seafood in a cooking pot of claim 21, further comprising at least a second zip-tie, wherein the inner support leg is fixed to the elongated cylindrical water discharging drop pipe with said at least a second zip-tie.

23. The portable water circulation device for flushing seafood in a cooking pot of claim 13, wherein the cylindrical conduit comprises a larger diameter than a diameter of the elongated cylindrical water discharging drop pipe.

24. The portable water circulation device for flushing seafood in a cooking pot of claim 13, the elongated cylindrical water discharging drop pipe further comprising an end cap connected to a bottom tip of the bottom portion of the elongated cylindrical water discharging drop pipe.

25. A portable ice chest water circulation device for flushing seafood, comprising:
a cylindrical conduit having a connector end opposite an elbow end, the cylindrical conduit having an elongated flat plate clamp leg disposed perpendicular to said cylindrical conduit, said elongated flat plate clamp leg having a lower end which defines an internally threaded hole and which comprises a threaded bolt disposed perpendicularly through said internally threaded hole, the threaded bolt adapted to engage an outer surface of a wall of an ice chest, the connector end comprising a water flow valve having a garden hose connection adapter configured to provide a fluid connection to a standard garden hose,
the elbow end comprising an elongated cylindrical water discharging drop pipe in fluid communication with the cylindrical conduit, the elongated cylindrical water discharging drop pipe having a top portion and a bottom portion, said top portion having a flat sidewall adapted to securely engage an inner surface of the wall of the ice chest in a removably mounted position, said bottom portion defining a linearly aligned row of round water discharging orifices;
wherein the elongated flat plate clamp leg engages the inner surface of the wall of the ice chest when the elongated cylindrical water discharging drop pipe is disposed inside the ice chest in the removably mounted position such that when the water flow valve is opened a flow of water through the elongated cylindrical water discharging drop pipe discharges said water out through said linearly aligned row of round water discharging orifices toward the inner surface of the wall of the ice chest in a spaced relationship to the elongated cylindrical water discharging drop pipe for circulating water therein while avoiding direct impact of said discharging water on the seafood when disposed therein.
